(19) United States
(12) Patent Application Publication
(10) Pub. No.: US 2015/0015564 A1
(43) Pub. Date: Jan. 15, 2015

(54) DISPLAY DEVICE

(71) Applicant: Japan Display Inc., Tokyo (JP)

(72) Inventor: Yasuhiko YAMAGISHI, Tokyo (JP)

(21) Appl. No.: 14/326,359

(22) Filed: Jul. 8, 2014

(30) Foreign Application Priority Data
Jul. 10, 2013 (JP) 2013-144384

(51) Int. Cl. G09G 3/36

(52) U.S. Cl. CPC G09G 3/3696
USPC 345/212; 345/87

(57) ABSTRACT

A display device includes a pixel array, a source driver, a gate driver, and a display control circuit. The pixel array has a plurality of pixels arranged in matrix. The source driver supplies the pixels with a gradation voltage in accordance with display data. The gate driver supplies the pixels with a gate signal for selecting the pixels to be supplied with the gradation voltage in the unit of rows. The display control circuit controls the source driver and the gate driver. The gate driver outputs gate selection pulses for precharging the pixels on the first line, in an effective display scanning period.

### CLAIM OF PRIORITY

The present application claims priority from Japanese patent application JP2013-144384 filed on Jul. 10, 2013, the content of which is hereby incorporated by reference into this application.

### BACKGROUND

The present invention relates to a display device, and is applicable to a display device which performs, for example, double-gate driving.

Display devices, so-called flat panel type display devices, are widely used, as color monitors of high definition for computer or other information units or display devices for TV receivers. This type of flat-panel type display devices typically are liquid crystal display devices. In recent years, organic EL display devices or plasma display devices are in the stage of practical use, and these devices include organic materials as a light-emitting device.

In this explanation, descriptions will be made to the schematic configuration of an active matrix type liquid crystal display device which is widely used. The liquid crystal display device has so-called a liquid crystal display panel, in which a liquid crystal layer is sandwiched between two (a pair of) substrates, at least one of which is basically a transparent glass. A voltage is applied (written) selectively to the electrodes for forming pixels formed on the substrate of the liquid crystal panel, to turn on and off predetermined pixels. Therefore, the device excels in contrast performance and high-speed display performance.

As the liquid crystal display devices are formed in a large size and have an improved degree of resolution, the allowable charging time of the pixels rapidly decreases, and the writing power failure occurs. Proposals have been made to a technique on double-gate driving (for example, Japanese Unexamined Patent Application Publication No. 2004-279741 (Patent Literature 1) or U.S. Pat. No. 7,446,760 (Patent Literature 2) corresponding thereto). In the technique for compensating for the decreased charging time and improving the writing, a preliminary voltage is applied to the gate of the pixels (thin film transistors) before the pixel writing, thereafter performing the actual writing.

### SUMMARY

In Japanese Unexamined Patent Application Publication No. 2004-279741 or U.S. Pat. No. 7,446,760, in the double-gate driving, gate selection pulses for precharging pixels are output in a vertical blanking period. The vertical blanking period randomly varies by a host circuit of the display device. By the variation of the vertical blanking period, gate selection pulses for precharging may not possibly be output at desired timings.

Another problem and new features will be obvious from the descriptions of this disclosure and attached drawings.

Of the disclosure, the representative schemes will simply be described as follows. That is, the display device starts outputting the gate selection pulses for precharging in a first line period of an effective display period.

According to the above-described display device, there is no need to consider about the timing variation of the vertical blanking period.

### BRIEF DESCRIPTION OF THE DRAWINGS

FIG. 1 is a timing diagram of double-gate driving in two-line inversion driving in a first embodiment.

FIG. 2 is a timing diagram of double-gate driving in one-line inversion driving in a second embodiment.

FIG. 3 is a timing diagram of double-gate driving in two-line inversion driving in a third embodiment.

FIG. 4 is a timing diagram of double-gate driving in one-line inversion driving in a fourth embodiment.

FIG. 5 is a timing diagram of double-gate driving in one-line inversion driving in a fifth embodiment.

FIG. 6 is a block diagram of a display control circuit according to the first embodiment.

FIG. 7 is a block diagram for explaining the scheme of a driving system of a liquid crystal display device.

FIG. 8 is a diagram illustrating a connection relationship of signal lines of the display control circuit, a gate driver unit, and a source driver unit.

FIG. 9 is a diagram illustrating a configuration of a liquid crystal display panel.

FIG. 10A and FIG. 10B are diagrams illustrating output waveforms of the gate driver unit and the source driver unit, and voltages to be written to thin film transistors of pixels, in two-line inversion driving.

FIG. 11 is a diagram illustrating pixel writing timing waveforms by double-gate driving.

FIG. 12 is a diagram illustrating timing waveforms of driver control by double-gate driving according to a comparative example.

FIG. 13A and FIG. 13B are diagrams illustrating timing waveforms when a vertical blanking period varies, in the double-gate driving according to the comparative example.

### DESCRIPTION OF THE PREFERRED EMBODIMENTS

Descriptions will now be made to the preferred embodiments and examples, using the drawings. In the following descriptions, the same reference numerals are given to the same constituent elements, and descriptions will not repeatedly be given thereto. Descriptions will be made to an active matrix liquid crystal display device. However, the present invention is not limited to this, and, needless to say, may be applied to another active matrix display device (for example, an organic EL display device).

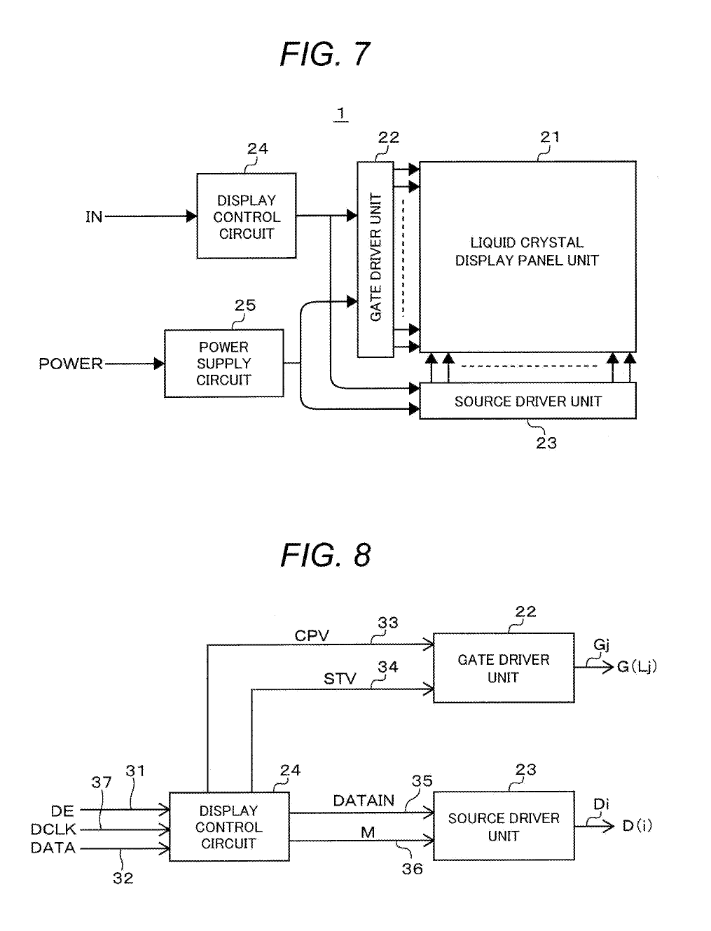

FIG. 7 is a block diagram for explaining the scheme of a driving system of a liquid crystal display device. The liquid crystal display device 1 includes a liquid crystal display panel 21, a gate driver unit 22, a source driver unit 23, a display control unit 24, and a power supply circuit 25. The gate driver unit 22 and the source driver unit 23 are arranged in a peripheral part of the liquid crystal display panel 21. The gate driver unit 22 is composed of a plurality of gate driver ICs arranged on one side of the liquid crystal display panel 21, the source driver unit 23 is composed of a plurality of source driver ICs arranged on the other side of the liquid crystal display panel 21, and are arranged on the circuit board of the liquid crystal display panel 21 (COG: Chip on Glass mounting), or arranged on the flexible printed circuit board (COF: Chip on Film mounting). In the case of the COF mounting, they are connected to a printed circuit board (PCB) including electronic equipment using an ACF (Anisotropic Conductive Film). The display control circuit 24 performs timing adjustment for a display signal (IN) input from a display signal source (host circuit) (such as non-illustrative personal computer or television receiving circuit), in accordance with the AC conversion of data or the display on the liquid crystal panel, converts it into display data in a display form, and gives the converted data to the gate driver unit 22 and the source driver unit 23 together with a synchronous signal (clock signal). The gate driver unit 22 and the source driver unit 23 supply gate signals to gate lines, under the control of the display control circuit 24, and supply display data to source lines, to display images. The power supply circuit 25 generates various voltages required for the liquid crystal display device 1, from a power source (POWER).

FIG. 8 is a diagram illustrating a connection relationship of signal lines of the display control circuit, the gate driver unit, and the source driver unit. To the display control circuit 24, a data enable signal (DE) is input through a signal line 31, and image data (DATA) is input through a signal line 32. To the gate driver unit 22, a gate clock signal (CPV) is transmitted from the display control circuit 24 through a signal line 33, and a gate selection enable signal (STV) is transmitted through a signal line 34. To the source driver unit 23, the image data (DATAIN) is transmitted from the display control circuit 24 through a signal line 35, and a signal (M) for determining a liquid crystal AC converter period is transmitted through a signal 36. The gate driver unit 22 outputs a gate selection voltage (G(Lj)) to a gate line Gj. The source driver unit 23 outputs a voltage (D (i)) to a drain line Di.

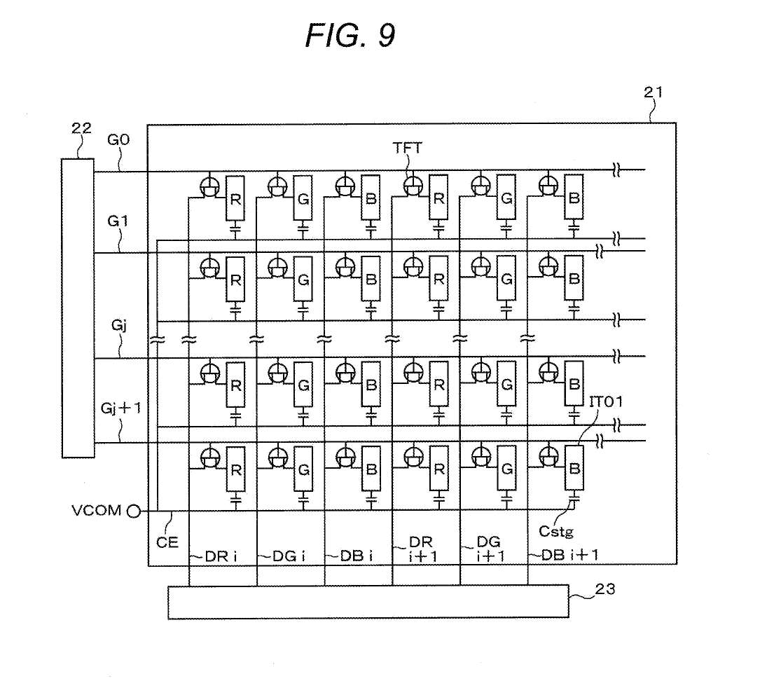

FIG. 9 is a diagram illustrating a configuration of a liquid crystal display panel. The liquid crystal display panel 21 has a pixel array having a plurality of pixels arranged in matrix. In the liquid crystal display panel 21, a drain electrode of a thin film transistor TFT of each pixel arranged in column direction is connected to a drain line D (DRi, DGi, DBi), and each drain line D is connected to the source driver unit 23 applying a voltage of display data of the pixels arranged in column direction. A gate electrode of the thin film transistor TFT in each pixel arranged in row direction is connected to a gate line G (G0, G1, . . . Gj, Gj+1), and the gate line G is connected to the gate driver unit 22 supplying a scanning driving voltage (a positive or negative bias voltage) to the gate of the thin film transistor TFT, during one horizontal scanning period. When a drawing is displayed on the liquid crystal display panel 21, the gate driver unit 22 selects the gate line (G0, G1, . . . Gj, Gj+1) from up to down (in order of G0 to G1), while the source driver 23 applies a voltage to the drain line D (DRi, DGi, DBi) in accordance with a signal level of the display data, during the selection period of some gate line, and this voltage is to be applied to the pixels.

It is assumed that the display panel operates in so-called a normally black-displaying mode, in which the high luminance is achieved as the display signal supplied to each pixel increases. The voltage applied to the drain line D is applied to a pixel ITO1 through the thin film transistor TFT of the pixel, and the capacity Cstg is eventually charged with charges, thereby controlling the liquid crystal. The other electrode of the capacity Cstg is a common electrode CE, and a common voltage (VCOM) is applied thereto. A liquid crystal driving voltage to be applied to the drain line D is output in a manner that it is a higher voltage (positive polarity) or lower voltage (negative polarity) than a constant common voltage (VCOM) to be applied to the common electrode CE. Its polarity is inversed at every one pixel and one line (1H), and the polarity of each line is inverted at every frame. In FIG. 9, pixel electrodes (source electrodes) corresponding to pixels of red (R), green (G), and blue (B) are denoted respectively as R, G, and B.

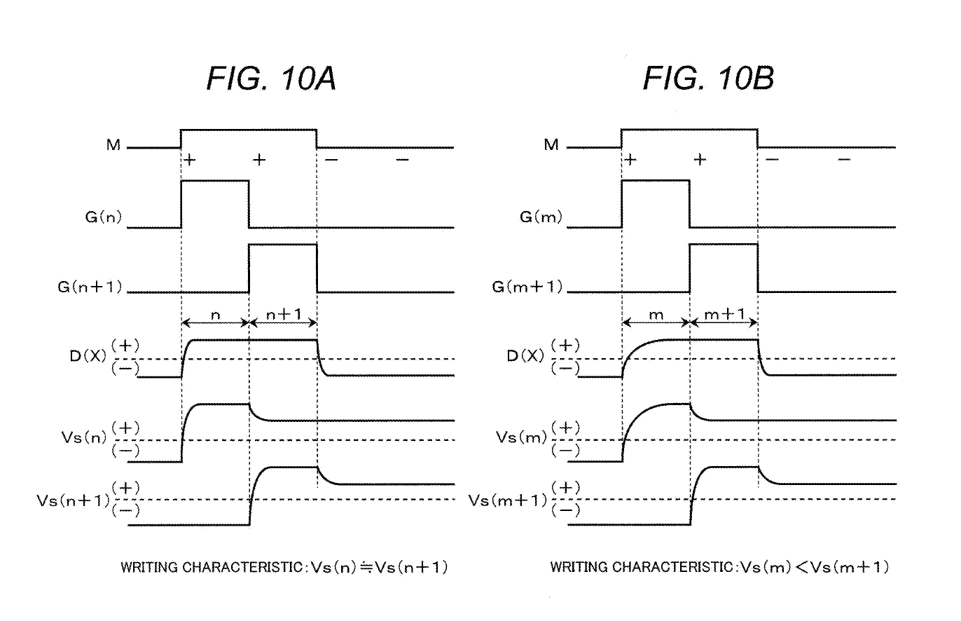

FIG. 10A and FIG. 10B are diagrams illustrating output waveforms of the gate driver unit and the source driver unit and voltages to be written to the thin film transistors of the pixels, in the two-line inversion driving. FIG. 10A illustrates near-end waveforms, while FIG. 10B illustrates far-end waveforms. A signal (M) is a control signal of the source driver determining the liquid converter period. G(n) represents a gate selection voltage of the n-th line gate line Gn which is output from the gate driver unit 22, G(n+1) represents a gate selection voltage of the gate line Gn+1, and D(x) represents an output voltage of the source driver of one drain line Dx. For example, when an image of a half tone raster is displayed, as illustrated in FIG. 10A, because there is no waveform rounding in the output voltage (D(x)) of the source driver in pixels close to the source driver unit 23, a writing voltage Vs (n) of a thin film transistor (may simply be referred to as a pixel) TFT of the pixel of the n-th line is substantially equal to a writing voltage Vs (n+1) of pixel TFT of the n+1-th line (Vs (n)≈Vs (n+)). Note that the writing voltage of the pixel TFT is a voltage that is written to the source electrode of the pixel TFT. In this case, the n-th line is farther away from the source driver unit 23 than the n+1-th line. As illustrated in FIG. 10B, in the pixel TFT arranged in a far end position from the source driver 23, waveform rounding occurs in the output voltage D(x) of the source driver at the driving on an m-th line under the influence of the wiring load of the drain line Dx. Thus, Vs (m+1) as a writing voltage for the m+1-th line becomes larger than Vs (m) as a writing voltage for the pixel TFT on the m-th line (Vs (m)<Vs (m+1)). There is a relationship of m<n. The m-th line is farther away from the source driver unit 23 than the m+1-th line. The writing potential difference between Vs (m) and Vs (m+1), that is, non-writing voltage is visually recognized as a luminance difference of display. This causes noise in the form of a streak on the screen, and causes also deterioration of the image quality.

### Principles of Double-Gate Driving

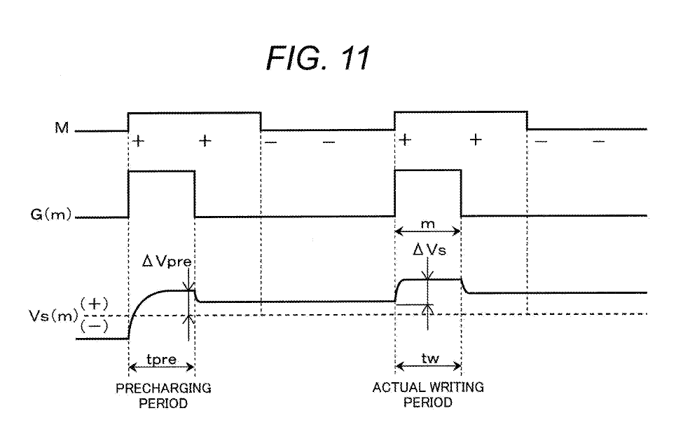

FIG. 11 is a diagram illustrating timing waveforms by double-gate driving. G(m) represents an output voltage of the gate driver unit 22 on the m-th line of the gate line Gm, Vs(m) represents a writing voltage of the pixel TFT arranged on the m-th line, and liquid crystal AC conversion polarity is inversion-driven at every two lines. In the case of double-gate driving, a voltage is applied to the pixel TFTs two times. At the first time, a voltage of ΔVpre corresponding to dummy image data is applied to the pixel TFT during a precharging period (tpre). After this, a voltage of ΔVs corresponding to display image data is applied during a actual writing period (tw). The pixel voltage reaches a target voltage by the writing of the two stages. Thus, the non-writing voltage is lower than the case in which the writing is performed simply at a time. If the double-gate driving is used, it is possible to solve some problem. That is, deterioration occurs in the image quality, because the non-writing voltage is visually recognized as a luminance difference of display, and also because noise (horizontal streak) occurs in the form of a streak on the screen.

Descriptions will now be made to the double-gate driving according to the technique (hereinafter referred to as a “comparative example”) which has been examined prior to this disclosure.

### Comparative Example

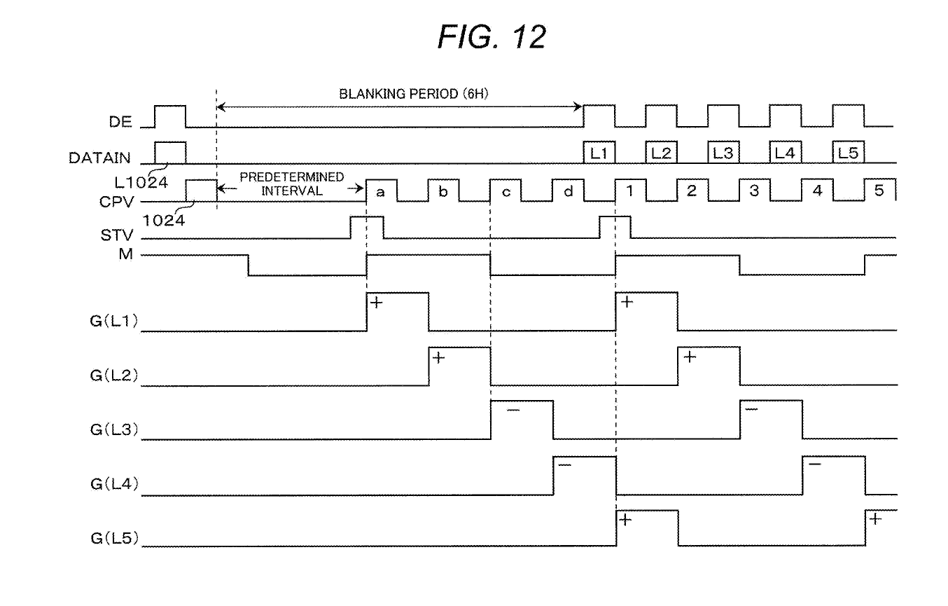

FIG. 12 is a diagram illustrating timing waveforms of driver control by the double-gate driving according to the comparative example. A blanking period (vertical blanking period) is six horizontal scanning periods (6H), since the end of the horizontal period of effective image data (DATAIN) (L1024) of the final line until DATAIN (L1) of the head line. In this case, one horizontal period (1H) is a period of DE or DATAIN after the head line, and is, for example, a period since the rising of DE corresponding to DATAIN (L1) until the rising of DE corresponding to DATAIN (L2). One horizontal period includes a display period and a blanking period (horizontal blanking period). The display control circuit 24 outputs CPVs (a, b, c, d) as four preliminary pulses (precharge pulses) for double-gate driving at an interval of 2.5H (predetermined interval) from a gate clock signal (CPV) (1024) of the final line. In this case, there is a relation of “blanking period (6H)”−“four preliminary pulses (3.5H)”=a predetermined interval (2.5H). The four preliminary pulses (a, b, c, d) are controlled in the unit of 1H, like the scanning of DATAIN. The gate selection enable signal (STV) is output in the period of the preliminary pulse (a) and after DATAIN (L1) is transferred to the source driver unit 23. In the effective display operation on the first line, G(L1) as a gate selection voltage is applied to the gate line G1 on the first line, while G(L5) as a gate selection voltage is applied to the gate line G5 on the fifth line. That is, the actual writing on the first line and the precharging on the fifth line are performed. In the effective display operation on the second line, G(L2) as a gate selection voltage is applied to the gate line G2 on the second line, while G(L6) as a gate selection voltage is applied to the gate line G6 on the sixth line. That is, the actual writing on the second line and the precharging on the sixth line are performed. The precharging and the actual writing are performed in the effective display operation on and after the third line.

The timing of DE randomly varies in accordance with the host circuit of the display device, and the vertical blanking period may vary. Descriptions will now be made to the case in which the vertical blanking period has varied.

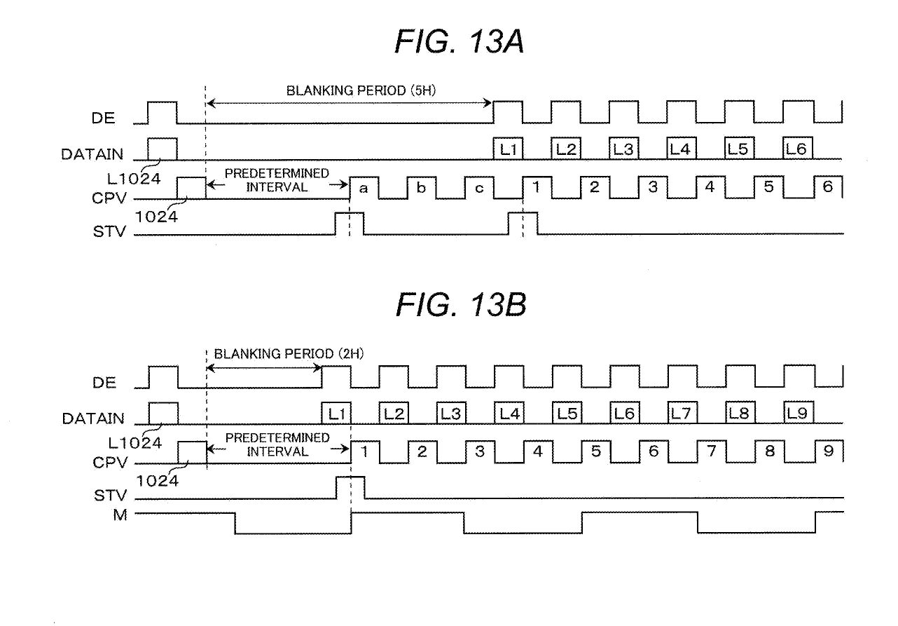

FIG. 13A and FIG. 13B are diagrams illustrating timing waveforms when the vertical blanking period has varied, in the double-gate driving of the comparative example. FIG. 13A illustrates a case in which the vertical blanking period is 5H, while FIG. 13B illustrates a case in which the vertical blanking period is 2H. The display control circuit 24 outputs a preliminary pulse(s) at an interval of 2.5H (predetermined interval) from the CPV (1024) on the final line. Thus, when the vertical blanking period is changed to 5H, though it originally is 6H, only three preliminary pulses (CPV (a), CPV (b), and CPV (c)) are output. Further, if the vertical blanking period is 2H, as illustrated in FIG. 13B, there is no preliminary pulse, and resulting in a problem that the double-gate driving cannot be performed.

The display device according to the embodiment includes a pixel array, a source driver (a first driver), a gate driver (a second driver), and a display control circuit. The pixel array has a plurality of pixels arranged in matrix. The source driver supplies the pixels with a gradation voltage in accordance with display data. The gate driver supplies the pixels with a gate signal for selecting the pixels to be supplied with the gradation voltage in the unit of rows. The display control circuit controls the source driver and the gate driver. The gate driver (the second driver) outputs gate selection pulses (first gate selection pulses) for precharging the pixels on the first line, during an effective display scanning period. In this case, the gate driver (the second driver) preferably outputs gate selection pulses (the second gate selection pulses) for the actual writing to the pixels on the same line to which the gate selection pulses (the first gate selection pulses) for precharging have been output.

Because the display device according to the embodiment outputs the gate selection pulses for precharging during the effective display period, there is no need to consider about the timing variation in the vertical blanking period. That is, even if a timing variation occurs in the vertical blanking period, it is possible to output the gate selection pulses for precharging.

If the double-gate driving is possibly performed, it is possible to reduce occurrence of a non-writing voltage of the pixel TFT, and also it is possible to improve the image quality without a horizontal streak or the like. There is no need to adjust the film thickness for the purpose of achieving low resistivity of the drain line, and thus reducing the load in a thin film transistor manufacturing process.

### Embodiment 1

A liquid crystal display device according to the first embodiment has the same configuration as those of FIG. 7, FIG. 8, and FIG. 9. However, the signals are output from the display control circuit at different timings.

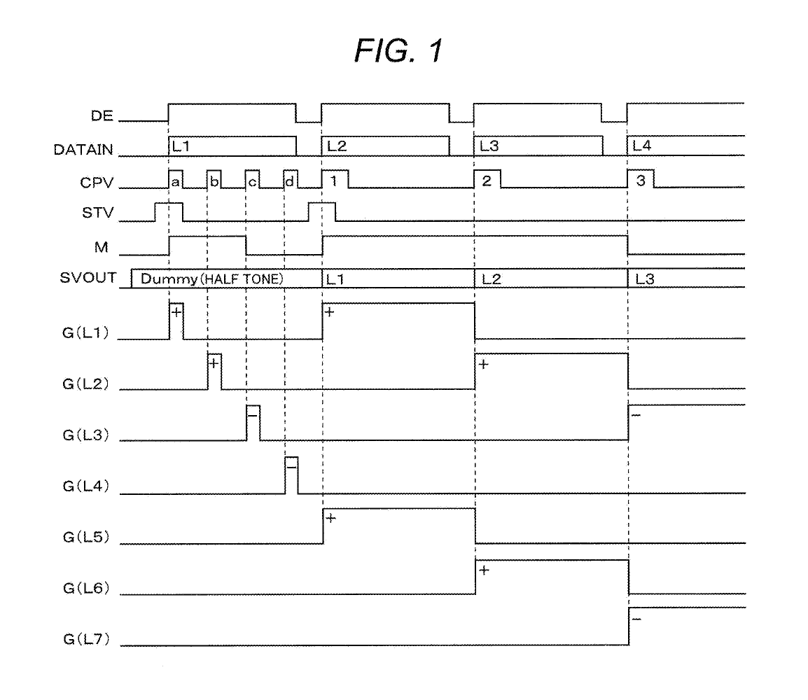

FIG. 1 is a timing diagram of double-gate driving in a two-line inversion driving in a first embodiment. A HIGH period of a data enable signal (DE) is an effective image data period, while its LOW period is a blanking period. Both image data (DATAIN) and a signal (M) for determining AC conversion polarity of a liquid crystal panel are signals to be input to the source driver unit 23 from the display control circuit 24. The DATAIN input to the source driver unit 23 is held by a latching circuit inside the source driver unit 23 during one horizontal scanning period. A gate clock signal (CPV) of the gate driver unit 22 and a gate selection enable signal (STV) are signals for controlling the gate driver unit 22. SVOUT represents a timing to apply a voltage to the liquid crystal display panel 21 through a drain line D from the source driver unit 23. G(L1) to G(L7) are as gate selection voltages to be applied from the gate driver unit 22 to the gate lines G1 to G7. HIGH periods of the G(L1) to the G(L7) imply selection periods, while LOW periods imply non-selection (pixel held) periods. “+/−” shown in the pulse period of the G(L1) to the G(L7) represents the liquid crystal AC conversion polarity at the selection.

In FIG. 1, the AC conversion period of the liquid crystal panel is set under the assumption of two-line inversion driving in which inversion is performed at every two horizontal scanning periods. The AC conversion polarities of “+”, “+”, “−”, and “−” forms one period. Thus, to output two gate selection pulses of the precharging and the actual writing and to match the pixel writing polarities with each other, it is necessary that four pulses (four preliminary pulses) are included in an interval of outputting two gate selection pulses. As a CPV, four preliminary pulses (a, b, c, d) are output, in a horizontal scanning period for sending the DATAIN (L1) on the first line to the source driver unit 23. The STV is latched with the CPV (a), and the STV is transferred to the next stage with other clock signals. A half tone raster dummy image data (Dummy) output from the source driver unit 23 is written into the pixel TFTs with the G(L1) to the G(L4) as gate selection pulses for precharging. Data to be written into the pixel TFTs with the gate selection pulses for precharging may be black image data.

To write display image data into the pixel TFTs, the STV is output again, after the DATAIN (L1) is transferred to the source driver unit 23. The STV is latched with the CPV (1). When the STV(1) is latched, it is the timing to output the G(L1) as a gate selection voltage for image writing to the gate line the G1 on the first line, and to output the G(L5) as a gate selection voltage for precharging to the gate line G5 on the fifth line. The STV (2) is latched with the CPV (2). When the STV (2) is latched, it is the timing to output the G(L2) as a gate selection voltage for image writing to the gate line G2 on the second line, and to output the G(L6) as a gate selection voltage for precharging to the gate line G6 on the sixth line. Similarly, in the scanning on the after the third line, vertical scanning is performed with a pair of gate selection voltage for precharging and image writing.

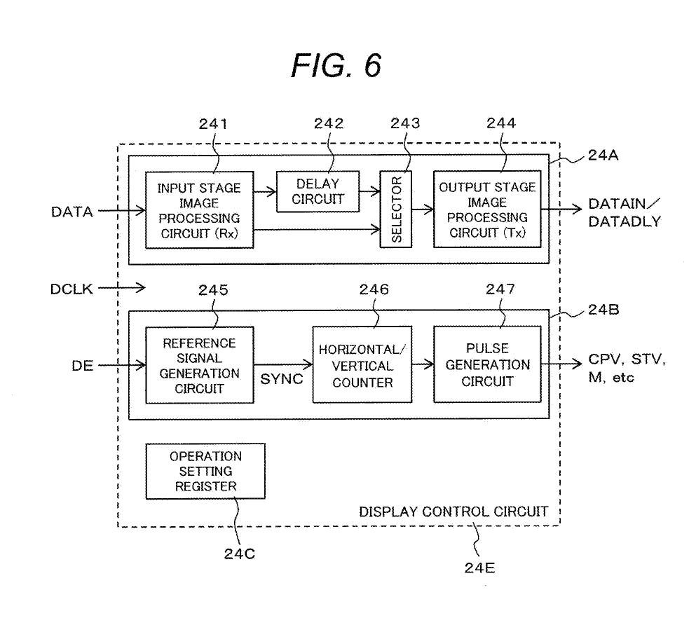

FIG. 6 is a block diagram of a display control circuit according to the first embodiment. A display control circuit 24E is composed of an image processing circuit 24A, a timing generation circuit 24B, and an operation setting register 24C. The circuit 24A controls briefly the timing of display images. The timing generation circuit 24B generates a control signal of a driver IC (the gate driver unit 22 and the source driver unit 23).

The image processing circuit 24A is composed of an input stage image processing circuit (Rx) 241, a delay circuit 242, a selector 243, and an output stage image processing circuit (Tx) 244. The circuit 241 adjusts a format (a series of data, for example, RGB or BGR) of image data sent from a non-illustrative host circuit. The circuit 242 delays the image data by one to two horizontal period(s). The selector 243 selects image data. The circuit 244 converts and processes data into an image format (for example, mini-LVDS) of the driver IC interface.

The timing generation circuit 24B is composed of a reference signal generation circuit 245, a counter (horizontal/vertical counter 246), and a pulse generation circuit 247. The circuit 245 generates an internal reference signal which is similar to a horizontal synchronous signal (HSYNC) and a vertical synchronous signal (VSYNC), from a DE signal. The counter 246 includes a horizontal counter counting up at each dot clock (DCLK) based on the SYNC and a vertical counter counting up at a horizontal synchronization period. The circuit 247 decodes a pulse width or period of each control signal of a driver IC, based on a value of the horizontal/vertical counter 246.

Pulse generation (decoded value) by the timing generation circuit 24B or operation setting of the image processing circuit 24A is operated and determined with reference to a value which is preset in the operation setting register 24C. As a register value of the operation setting register 24C, data written into a non-volatile memory (for example, EEPROM) is read to the register at the beginning of power supply, and the value is set in each circuit inside the display control circuit 24E.

The number of dot clocks in one horizontal period (1H) at a normal operation is assumed as 800dclk, the pulse HIGH width of the CPV is assumed as 400dclk, and the period of CPV is assumed as 800dclk which is equal to 1H.

In this embodiment, some settings are made. That is, a register of the operation setting register 24C is set without using a delay process of the image processing circuit 24A, and four CPV pulses are output on the head first line and at every 1H thereafter. The pulse generation circuit 247 sets four decoded values 0, 200, 400, and 600 [dec] of the counter determining the period on the head first line, adds a value (because the period is shortened) whose CPV pulse width has been reduced from 400dclk to 100dclk (=400dclk/4), to the above-described four decoded values, and sets the decoded values 100, 300, 500, and 700 of the counter in the HIGH period of the CPV pulse. In the pulse generation circuit 247, when the counter decoded value is “0” [dec], the CPV is HIGH, and when the value is “100” [dec], the CPV is LOW. After this, “1” and “0” are repeatedly generated at each decoding of the counter, to form one CPV.

In the above-described circuit operations, signals are formed based on the same idea, for any other driver control signal.

### Embodiment 2

A liquid crystal display device according to a second embodiment is the same as the liquid crystal display device according to the embodiment 1. The difference therebetween is a register setting value of the operation setting register of the display control circuit 24E. That is, signals are output from the display control circuit 24E at different timings.

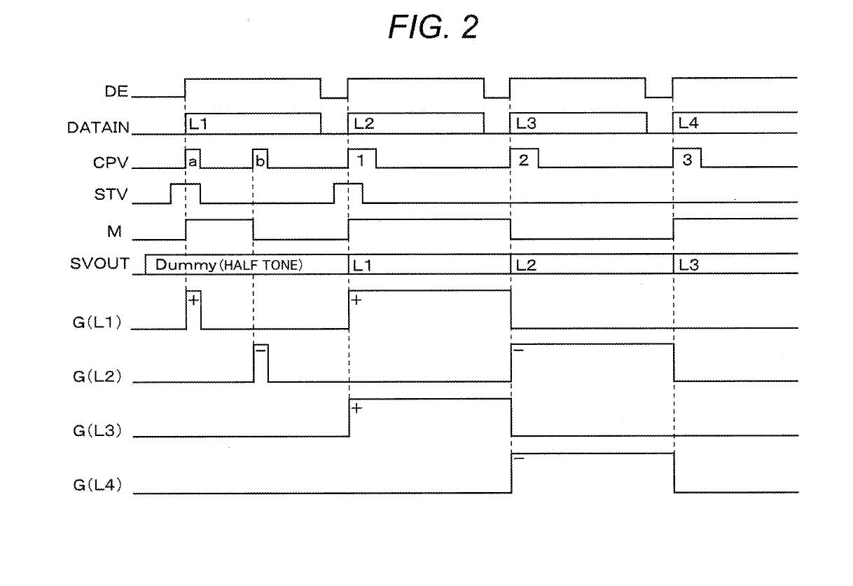

FIG. 2 is a timing diagram of double-gate driving in one-line inversion driving in a second embodiment. In FIG. 2, the AC conversion period of the liquid crystal panel is set under the assumption of one-line inversion driving in which the inversion is performed at every one horizontal scanning period. The AC conversion polarity of “+” and “−” forms one period. Thus, to output two gate selection pulses and to match the writing polarities of the pixel TFTs, it is necessary that two pulses are included in a timing interval for outputting a pulse. Two preliminary pulses (a, b) are output to the source driver unit 23 with a CPV, in a horizontal scanning period for sending the DATAIN (L1) on the first line. An STV for precharging is latched with the CPV (a), and an STV is transferred to the next stage with other clocks. Using the G (L1) as a gate selection pulses for precharging, dummy image data (Dummy) is written into the pixel TFTs. This data is half tone raster data to be output from the source driver unit 23. Because the display image data is written into the pixel TFTs, the STV is output again, after the DATAIN (L1) is transferred to the source driver unit 23. In the timing when the STV is HIGH at the second time, the G(L1) as the gate selection voltage for precharging is output to the gate line G1 on the first line, while the G (L3) as the gate selection voltage for precharging is output to the gate line G3 on the third line. Further, it is the timing when the G(L2) as the gate selection voltage for image writing is output to the gate line G2 on the second line, while the G (L4) as the gate selection voltage for precharging is output to the gate line G4 on the fourth line. In the scanning on the L3 on and after the third line, vertical scanning is performed with a pair of gate selection voltages for precharging and image writing.

In this embodiment, some settings are made. That is, a register of the operation setting register 24C is set without using a delay process of the image processing circuit 24A, and two CPV pulses are output on the head first line and at every 1H thereafter. The pulse generation circuit 247 sets two decoded values 0 and 400 [dec] of the counter for determining the period on the head first line, adds a value (because the period is shortened) whose CPV pulse width has been reduced from 400dclk to 100dclk (=400dclk/4), to the above-described two decoded values, and sets the decoded values 100 and 500 of the counter in the HIGH period of the CPV pulse. In the pulse generation circuit 247, when the counter decoded value is “0” [dec], a CPV is HIGH, and when the value is “100” [dec], the CPV is LOW. After this, “1” and “0” are repeatedly generated at each decoding of the counter, to form one CPV.

### Embodiment 3

A liquid crystal display device according to a third embodiment is the same as the liquid crystal display device according to the first embodiment. The difference therebetween is a register setting value of an operation setting register of the display control circuit 24E. That is, signals are output from the display control circuit 24E at different timings.

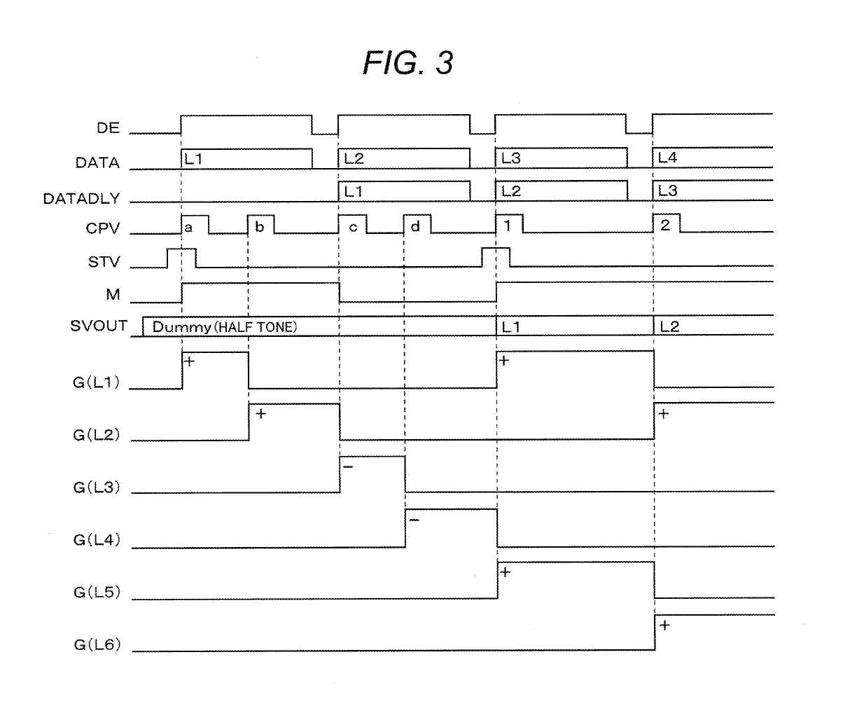

FIG. 3 is a timing diagram of double-gate driving in two-line inversion driving according to the third embodiment. FIG. 3 illustrates an example in which the driving timing of FIG. 1 is applied. In FIG. 1, gate selection is performed for four times in one horizontal scanning period. Thus, the operation frequency of the gate driver unit 22 is highly limited, and a load is largely applied on the liquid crystal panel 21. It may result in a difficultly of the driving. Descriptions will hereinafter be made to a driving method for avoiding this difficultly.

In FIG. 3, the AC conversion period of the liquid crystal panel is set under the assumption of two-line inversion driving in which inversion is performed at every two horizontal scanning periods. Image data (DATA) retrieved inside the display control circuit 24E is delayed by one horizontal scanning period by a line memory (delay circuit 242) of the display control circuit 24E, and the delayed image data (DATADLY) is sent to the source driver unit 23. Four preliminary pulses (a, b, c, d) of CPV are output to the gate driver unit 22 during the periods of the DATA (L1) and DATA (L2). In the above periods, because four gate pulses are output in the two horizontal scanning periods, the gate selection time is longer than that of FIG. 1. In CPV (a), an STV for precharging is latched, and the STV is transferred to the next stage with other clocks. A half tone raster dummy image data (Dummy) output from the source driver unit 23 during the two horizontal scanning periods is written into the pixel TFTs, using the G (L1) as gate selection pulses for precharging. Because display image data is written into the pixel TFTs, the STV is output again, after the DATADLY (L1) is transferred to the source driver unit 23. In the timing when the STV is HIGH at the second time, the G(L1) as a gate selection voltage for image writing is output to the gate line G1 on the first line, while the G(L5) as a gate selection voltage for precharging is output to the gate line G5 on the fifth line. The G(L2) as a gate selection voltage for image writing is output to the gate line G2 on the second line, while the G(L6) as a gate selection voltage for precharging is output to the gate line G6 on the sixth line. Also in the scanning of the L3 image on and after the third line, vertical scanning is performed with a pair of gate selection voltages for precharging and for image writing.

In this embodiment, some settings are made. That is, a register of the operation setting register 24C is set without using a delay process (delay circuit 242) of the image processing circuit 24A, and two CPV pulses are output on and until the second line. In the periods up to the second line, the decoded values of the counter are 0 and 400 [dec], the decoded values of the counter in the HIGH period of the CPV pulse are 200 and 600 [dec].

### Embodiment 4

A liquid crystal display device according to a fourth embodiment is the same as the liquid crystal display device according to the embodiment 1. The difference therebetween is a register setting value of the operation setting register of the display control circuit 24E. That is, signals are output from the display control circuit 24E at different timings.

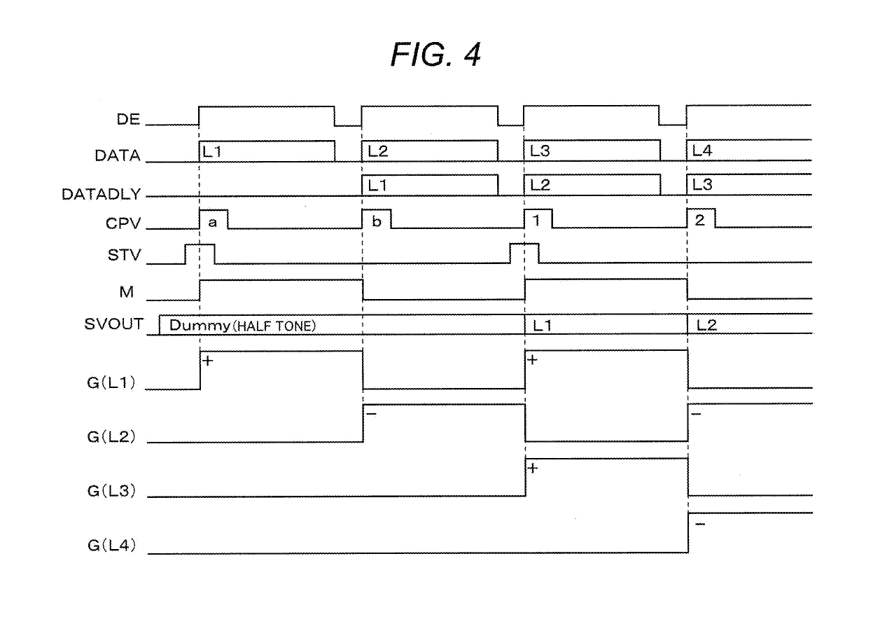

FIG. 4 is a timing diagram of double gate driving in one-line inversion driving in the fourth embodiment. FIG. 4 illustrates an example in which the driving timings of FIG. 2 are applied. As described in FIG. 3, image data (DATADLY) delayed by a line memory (delay circuit 242) of the display control circuit 24E is sent to the source driver unit 23. In addition, like FIG. 2, two (a, b) preliminary pulses (pulses for precharging) are output as a CPV, and illustration is made on timings for performing double-gate driving. The gate selection period for precharging in the timing of the CPV (a, b) is short, that is, a ½ horizontal scanning period in the embodiment 2 illustrated in FIG. 2. However, in the example of FIG. 4, the gate selection period is one horizontal scanning period which is equal to the selection period in normal image scanning.

An STV for precharging is latched with the CPV (a), and the STV is transferred to the next stage using another clock. Using the G(L1) as gate selection pulses for precharging, halftone raster dummy image data (Dummy) is written into the pixel TFTs. This image data is output from the source driver unit 23 in the two-horizontal scanning period. Because the display image data is written into the pixel TFTs, the STV is output again, after the DATADLY (L1) is transferred to the source driver unit 23. In the above-described scanning timing, the G(L1) as the gate selection voltage for image writing is output to the gate line G1 on the first line, while the G(L3) as the gate selection voltage for precharging is output to the gate line G3 on the third line. The G(L2) as the gate selection voltage for image writing is output to the gate line G2 on the second line, while the G(L4) as the gate selection voltage for precharging is output to the gate line G4 on the fourth line. Also in the scanning of the L3 image on and after the third line, vertical scanning is performed with a pair of gate selection voltages for precharging and image writing.

### Embodiment 5

A liquid crystal display device according to a fifth embodiment is the same as the liquid crystal display device according to the embodiment 1. The difference therebetween is a register setting value of the operation setting register of the display control circuit 24E. That is, signals are output from the display control circuit 24E at different timings.

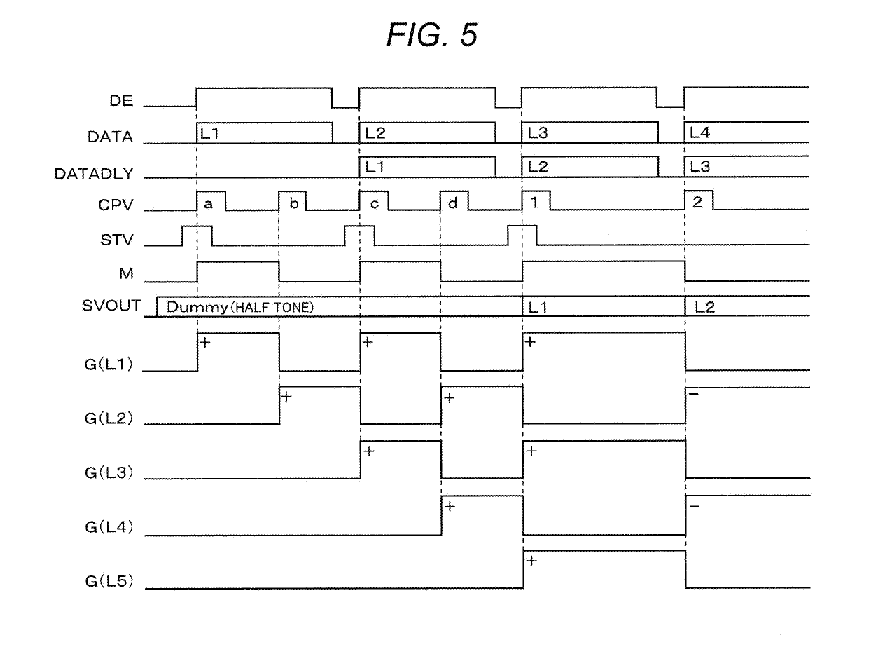

FIG. 5 is a timing diagram of triple-gate driving in one-line inversion driving in the fifth embodiment. FIG. 5 illustrates an example in which driving timings of FIG. 4 are applied. FIG. 5 illustrates driving timings, in which totally three selection pulses are output from the gate driver. Specifically, the three selection pulses include two gate selection pulses for precharging and one selection pulse for image writing. Because one more gate selection pulse for precharging is applied, four preliminary pulses (a, b, c, d) are necessary. Any other driving ideas are the same as those of FIG. 4.

An STV for precharging is latched with the CPV (a), and the STV is transferred to the next stage using another clock. Using the G(L1) as gate selection pulses for precharging, half tone raster dummy image data (Dummy) is written into the pixel TFTs. The image data is output from the source driver unit 23 in the two horizontal scanning periods. Because the display image data is written into the pixel TFTs, the STV is output again, after the DATADLY (L1) is transferred to the source driver 23. In the timing when the STV is HIGH at the second time, the G(L1) as the gate selection voltage for image writing is output to the gate line G1 on the first line, the G(L3) as the gate selection voltage for precharging is output to the gate line G1 on the third line, and the G(L5) as the gate selection voltage for precharging is output to the gate line G1 on the fifth line. The G(L2) as the gate selection voltage for image writing is output to the gate line G2 on the second line, the G(L4) as the gate selection voltage for precharging is output to the gate line G4 on the fourth line, and the G(L6) as the gate selection voltage for precharging is output to the gate line G6 on the sixth line. Also in the scanning of the L3 image on and after the third line, vertical scanning is performed with a set of gate selection voltages that include two for precharging and one for image writing.

Accordingly, the invention of the present inventor has been described specifically based on the preferred embodiments and examples. However, the present invention is not limited to the above-described embodiments and examples, and, needless to say, various changes may be made thereto.

What is claimed is:

1. A display device comprises:
a pixel array which has a plurality of pixels arranged in matrix;
a source driver which supplies the pixels with a gradation voltage in accordance with display data;
a gate driver which supplies the pixels with a gate signal for selecting the pixels to be supplied with the gradation voltage in unit of rows; and
a display control circuit which controls the source driver and the gate driver, and
wherein the gate driver outputs gate selection pulses for precharging the pixels on a first line in an effective display scanning period.

2. The display device according to claim 1, wherein
the display control circuit outputs a plurality of clocks to the gate driver, to send the gate selection pulses for precharging in one horizontal scanning period.

3. The display device according to claim 1, wherein the display control circuit causes image data to be delayed and sends the image data to the source driver, to extend a period of the gate selection pulses for precharging to be output from the gate driver in an effective display period.

4. The display device according to claim 1, wherein the display control circuit outputs dummy image data other than black raster display data in a period for outputting the gate selection pulses for precharging.

5. The display device according to claim 1, wherein the display control circuit changes number of output pulses of the gate selection pulses for precharging, in accordance with an AC conversion period of the display device.

6. The display device according to claim 1, wherein the gate driver outputs gate selection pulses for actual writing for pixels on a same line to which the gate selection pulses for precharging have been output.

7. The display device according to claim 6,
wherein the gate selection pulses for actual writing is output in a horizontal scanning period next to a horizontal scanning period in which the gate selection pulses for precharging have been output.

8. A display device comprising:
a pixel array which has a plurality of pixels arranged in matrix;
a first driver;
a second driver; and
a display control circuit, and wherein
each of the plurality of pixels has a thin film transistor,
the first driver supplies the plurality of pixels with a gradation voltage in accordance with display data,
the second driver supplies the plurality of pixels with a gate signal for selecting the plurality of pixels to be supplied with the gradation voltage in unit of rows,
the display control circuit controls the first driver and the second driver,
the second driver outputs first gate selection pulses to the pixels on a first line in an effective display scanning period,
the second driver outputs second gate selection pulses to the pixels on a same line to which the first gate selection pulses have been output, and
the second gate selection pulses are output in a horizontal scanning period next to a horizontal scanning period in which the first gate selection pulses have been output.

9. The display device according to claim 8, wherein the display control circuit outputs a plurality of clocks to the second driver, to send the first gate selection pulses in one horizontal scanning period.

10. The display device according to claim 8, wherein the display control circuit causes image data to be delayed and sends the image data to the first driver, to extend a period of the first gate selection pulses to be output from the second driver in an effective display period.

11. The display device according to claim 8, wherein the display control circuit outputs dummy image data other than black raster display data in a period for outputting the first gate selection pulses.

12. The display device according to claim 8, wherein the display control circuit changes number of output pulses of the first gate selection pulses, in accordance with an AC conversion period of the display device.

13. A display device comprises
a plurality of source lines;
a plurality of gate lines;
a first driver;
a second driver; and
a display control circuit, and
wherein the first driver supplies the plurality of source lines with display data,
the second driver supplies the plurality of gate lines with a gate signal,
the display control circuit controls the first driver and the second driver,
the second driver outputs first gate selection pulses to the gate line of a first line in an effective display scanning period,
the second driver outputs second gate selection pulses to the gate line of a same line to which the first gate selection pulses have been output, and
the second gate selection pulses are output in a horizontal scanning period next to a horizontal scanning period in which the first gate selection pulses have been output.

14. The display device according to claim 13, wherein the display control circuit outputs a plurality of clocks to the second driver, to send the first gate selection pulses in one horizontal scanning period.

15. The display device according to claim 13, wherein the display control circuit causes image data to be delayed and sends the image data to the first driver, to extend a period of the first gate selection pulses to be output from the second driver in an effective display period.

16. The display device according to claim 13, wherein the display control circuit outputs dummy image data other than black raster display data, in a period for outputting the first gate selection pulses.

17. The display device according to claim 13, wherein the display control circuit changes number of output pulses of the first gate selection pulses, in accordance with an AC conversion period of the display device.
